(19) United States
(12) Patent Application Publication
(10) Pub. No.: US 2013/0255510 A1
(43) Pub. Date: Oct. 3, 2013

(54) ELECTRIC MEAT DRAINER

(71) Applicant: Linda Kassis, Carmel, IN (US)

(72) Inventor: Linda Kassis, Carmel, IN (US)

(21) Appl. No.: 13/435,459

(22) Filed: Mar. 30, 2012

(51) Int. Cl. A22C 7/00

(52) U.S. Cl. 99/486; 99/495; 99/493

(57) ABSTRACT

One example embodiment includes an electric meat drainer for removing FOG from a meat product. The electric meat drainer includes a container. The container is configured to retain a meat product and allow FOG to freely exit the container. The electric meat drainer also includes a press. The press is configured to move relative to the container and apply pressure to the meat product within the container, where the pressure separates FOG from the meat product, allowing the FOG to exit the container. The electric meat drainer further includes a motor, where the motor is configured to move the press relative to the container. The electric meat drainer additionally includes a FOG container, where the FOG container is configured to receive the FOG which exits the container.

### CROSS-REFERENCE TO RELATED APPLICATIONS

Not applicable.

### BACKGROUND OF THE INVENTION

Fats, oils and greases (FOG) are a necessary part of any healthy diet. FOG is beneficial as it allows us to properly develop. Indeed, some vitamins and nutrients are only present in FOG and must be obtained through ingesting FOG. However, these substances form an increasing large portion of humans' diets. This is a result of diets that include higher proportions of meat and meat that has higher fat content. Many animals raised for meat get very little exercise increasing the amount of fat present in meat. In addition, some people believe that higher fat content makes meat more flavorful and/or gives the meat a better texture.

Nevertheless, FOG is very high in calories. In fact, FOG includes some of the most calorie dense food that can be ingested. It is likely that increased portions of calorie dense foods, such as FOG, are at least partially to blame for increased obesity, diabetes, heart attacks and other diseases associated with unhealthy diets. As a result, many individuals have strived to reduce the amount of FOG that they receive in their diet. This can take the form of purchasing low fat foods or in removing some of the FOG from regular foods.

The removal of FOG from food can take many forms. For example, many people place cooked meat on a paper towel or other material which absorbs the FOG. The meat is then eaten and the material is disposed of. Additionally, some individuals drain meat using a strainer or other method that retains the meat but allows the FOG to exit. These methods all share the fact that they are passive. I.e., any FOG that happens to be removed is removed but any FOG that is retained is consumed. This leaves a large portion of the FOG within the cooked meat.

However, this leads to an additional problem, namely that the FOG is often improperly disposed of. In particular, the FOG begins to smell if placed in the garbage or otherwise left near the home. This can attract vermin such as mice and rats which smell the disposed of FOG. This results in many individuals simply dumping the FOG down the drain either in a sink or other area, such as a toilet. As the FOG comes in contact with the plumbing, it becomes retained, since it repels water, and eventually can lead to clogged pipes. In addition, large amounts of FOG can make water treatment more difficult.

Accordingly, there is a need in the art for a device which can allow FOG to be actively removed from food. In addition, there is a need in the art for the device to allow for proper disposal of the removed FOG. Further, there is a need in the art for the device to allow the FOG to be removed automatically, making it more likely for the user to use the device. Moreover, there is a need in the art for the device to allow the user to determine the amount of FOG removed.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an electric meat drainer for removing FOG from a meat product. The electric meat drainer includes a container. The container is configured to retain a meat product and allow FOG to freely exit the container. The electric meat drainer also includes a press. The press is configured to move relative to the container and apply pressure to the meat product within the container, where the pressure separates FOG from the meat product, allowing the FOG to exit the container. The electric meat drainer further includes a motor, where the motor is configured to move the press relative to the container. The electric meat drainer additionally includes a FOG container, where the FOG container is configured to receive the FOG which exits the container.

Another example embodiment includes an electric meat drainer for removing FOG from a meat product. The electric meat drainer includes a container. The container is configured to retain a meat product and allow FOG to freely exit the container. The electric meat drainer also includes a press. The press is configured to move relative to the container and apply pressure to the meat product within the container, where the pressure separates FOG from the meat product, allowing the FOG to exit the container. The electric meat drainer further includes a motor, where the motor is configured to move the press relative to the container. The electric meat drainer additionally includes a collection chamber, where the collection chamber is configured to receive the FOG which exits the container. The electric meat drainer also includes a FOG container, where the FOG container is configured to receive the FOG which exits the container.

Another example embodiment includes an electric meat drainer for removing FOG from a meat product. The electric meat drainer includes a container. The container is configured to retain a meat product and allow FOG to freely exit the container. The electric meat drainer also includes a press. The press is configured to move relative to the container and apply pressure to the meat product within the container, where the pressure separates FOG from the meat product, allowing the FOG to exit the container. The electric meat drainer further includes a stirrer, where the stirrer is configured to agitate the meat product within the container. The electric meat drainer additionally includes a cover, where the cover is configured to shield at least a portion of the container, the press and the stirrer. The electric meat drainer also includes a motor, where the motor is configured to move the press relative to the container and move the stirrer relative to the container, moving the meat product within the container. The electric meat drainer further includes a collection chamber, where the collection chamber is configured to receive the FOG which exits the container. The electric meat drainer additionally includes a frame, where the frame holds the position of the container relative to the collection chamber. The electric meat drainer also includes a FOG container, where the FOG container is configured to receive the FOG which exits the container. The electric meat drainer further includes a scale. The scale is configured to measure the weight of the meat product placed in the container and measure the weight of the FOG removed from the meat product. The electric meat drainer additionally includes a display. The display is configured to show to a user the amount of FOG in the original meat product removed by the electric meat drainer.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of an electric meat drainer;

FIG. 2 illustrates an example of an electric meat drainer;

FIG. 3 illustrates an example of a colander for use with an electric meat drainer; and

FIG. 4 illustrates an example of a meat press.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

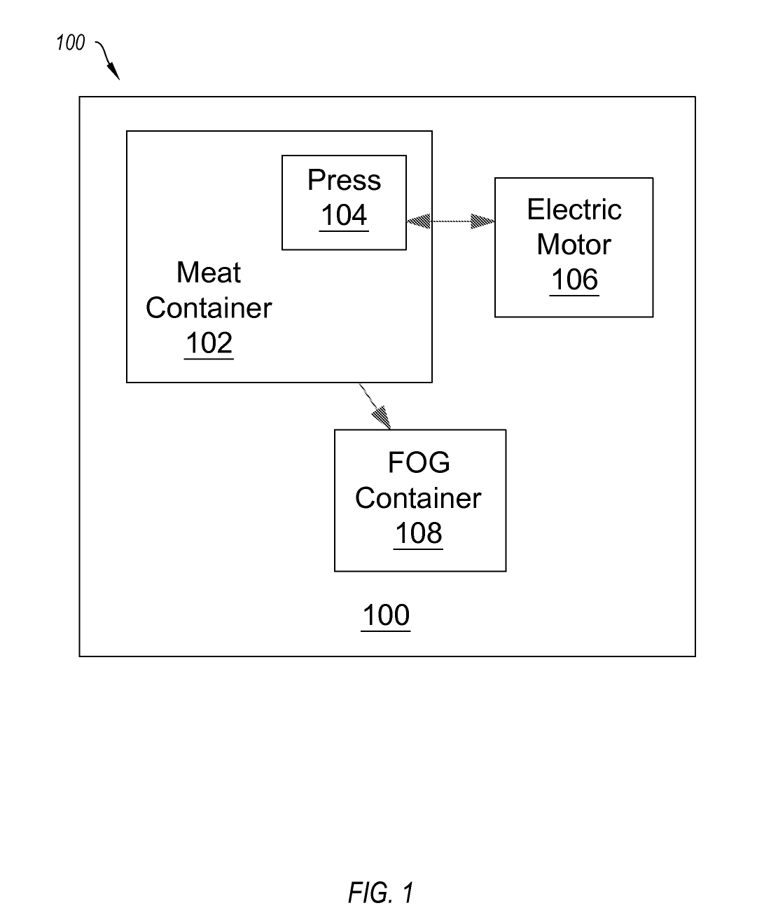

FIG. 1 is a block diagram illustrating an example of an electric meat drainer 100. In at least one implementation, the electric meat drainer can be used to remove fats, oils and grease (FOG) from a meat product. For example, the electric meat drainer 100 can be used to remove FOG from hamburger, beef, turkey, pork, chicken or any other meat product.

FIG. 1 shows that the electric meat drainer 100 can include a meat container 102. In at least one implementation, the meat container 102 can be configured to hold the meat product while the FOG is being removed. For example, the meat container 102 can include a bowl or the other container. The meat container 102 can include one or more features which allow the FOG to be removed. For example, the meat container 102 can include holes, ridges, filters, mesh or other features that allow the FOG to exit the meat container 102.

FIG. 1 further shows that the electric meat drainer 100 can include a press 104. In at least one implementation, the press 104 is configured to apply pressure to the meat product. In particular, the press 104 can move in relation to the meat container 102, creating pressure on any meat product in the meat container 102. The pressure can remove FOG which is then removed or otherwise eliminated, leaving only meat product without excess FOG.

FIG. 1 additionally shows that the electric meat drainer 100 can include an electric motor 106. In at least one implementation, the electric motor 106 can be used to move the press 104 relative to the meat container 102. I.e., the electric motor 106 can convert electrical energy into mechanical energy which moves the press 104 relative to the container 102. The movement of the press 104 can create a pressure which forces the FOG out of the meat product within the meat container 102.

FIG. 1 also shows that the electric meat drainer 100 can include a FOG container 108. In at least one implementation, the FOG container 108 can receive the removed FOG. I.e., as the meat product in the meat container 102 is pressed by the press 104 excess FOG is removed. The FOG can enter the FOG container 108 where it can be disposed of. For example, the FOG container 108 can be a disposable container that may be thrown away with the collected FOG. I.e., the FOG container 108 can be biodegradable, such that it can be disposed of along with the collected FOG. Additionally or alternatively, the FOG container 108 can include a container which is plastic or glass and from which the FOG can be washed or otherwise eliminated.

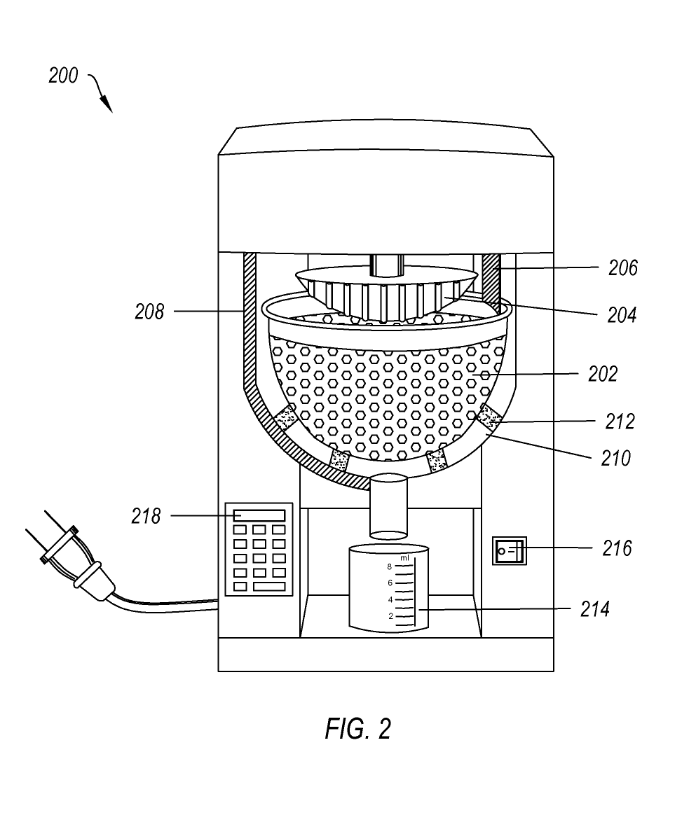

FIG. 2 illustrates an example of an electric meat drainer 200. In at least one implementation, the electric meat drainer 200 can be used to remove FOG from a meat product. Additionally or alternatively, the electric meat drainer 200 can indicate the original amount of FOG to the user. I.e., the electric meat drainer 200 can display to the user the original amount of FOG present in the meat product and/or how much FOG was removed.

FIG. 2 shows that the electric meat drainer 200 can include a colander 202. In at least one implementation, the colander 202 can include a bowl-shaped container with holes or slots. The colander 202 can be perforated to allow the colander 202 to retain the meat product while the FOG is removed. I.e., the perforated nature of the colander 202 allows liquid to drain through while retaining the solids inside. The colander 202 can be made of a metal, such as aluminum or thinly rolled stainless steel, plastic, silicone or any other desired material.

FIG. 2 also shows that the electric meat drainer 200 can also include a meat press 204. In at least one implementation, the meat press 204 is configured to press the meat product within the colander 202. I.e., the meat press 204 can be moved relative to the colander 202. The pressure on the meat product by the colander 202 and the meat press 204 can cause the FOG to be removed from the meat product. The FOG can then be moved, both by the pressure and the force of gravity, through the holes in the colander 202 where it is removed.

In at least one implementation, the meat press 204 can be any desired shape to properly remove FOG from the meat product. For example, the meat press 204 can be approximately the same shape as the colander 202. Additionally or alternatively, the meat press 204 can include different parts that allow the user to press different quantities of meat product. For example, the meat press 204 can include a first press that is smaller and fits to the bottom of the colander 202 for smaller quantities of meat product. In addition, the meat press 204 can include a second press that is larger and presses larger quantities of meat product.

FIG. 2 further shows that the electric meat drainer 200 can include a stirrer 206. In at least one implementation, the stirrer 206 is configured to stir the meat product within the colander 202. This can ensure that the maximum amount of FOG is removed from the meat product, as described below.

FIG. 2 additionally shows that the electric meat drainer 200 can include a cover 208. In at least one implementation, the cover 208 is configured to shield at least a portion of the electric meat drainer 200. In particular, the cover 208 can restrict access to the colander 202, the meat press 204 or the stirrer 206. For example, the cover 208 may need to be closed in order for the motor to move either the meat press 204 or the stirrer 206.

FIG. 2 also shows that the electric meat drainer 200 can include a collection chamber 210. In at least one implementation, the collection chamber 210 can be configured to collect FOG which has been removed from the meat product. I.e., as the meat press 204 presses the meat product, the FOG passes through the holes in the colander 202 and is collected in the collection chamber 210.

FIG. 2 further shows that the electric meat drainer 200 can include a frame 212. In at least one implementation, the frame 212 can hold the position of the colander 202 relative to the collection chamber 210. I.e., the frame 212 can ensure that the colander 202 remains supported within the collection chamber 210 while allowing enough room for FOG to exit the colander 202.

FIG. 2 also shows that the electric meat drainer 200 can include a FOG container 214. In at least one implementation, the FOG container 214 can receive FOG from the collection chamber 210. For example, the FOG container 214 can receive the FOG directly from the colander 202 or it can be moved from the collection chamber 210 to the FOG container 214. E.g., the FOG container 214 can include a liner which is placed within the collection chamber 210. Additionally or alternatively, the collection chamber 210 can include a chute, at the end of which is the FOG container 214. The FOG container 214 can include a lid or other mechanism to retain the FOG, as desired.

FIG. 2 further shows that the electric meat drainer 200 can include a switch 216. In at least one implementation, the switch 216 can allow a user to determine when the electric meat drainer 200 is active. In particular, the switch 216 can be connected to a motor which moves the meat press 204 relative to the colander 202. Additionally or alternatively, the switch 216 can include one or more safety mechanisms. For example, the switch 216 can prevent operation of the motor if the meat press 204 is not present or not properly attached. In addition, the switch 216 can prevent operation if one or more sensors detect something is wrong. For example, if an installed sensor detects that a portion of a person's hand or other body part is in a position to be damaged by the meat press 204 the switch 216 can stop the motor from working. Additionally or alternatively, the switch 216 can prevent operation if the cover 208 is not closed.

In at least one implementation, the switch 216 can include a timer. For example, the timer can activate the electric meat drainer 200 for a predetermined amount of time. I.e., the timer can maintain the pressure of the meat press 204 for a predetermined time, removing as much FOG as is practicable. Additionally or alternatively, the timer can complete a desired cycle. For example, the time can press the meat product using the meat press 204, stir the meat product using the stirrer 206, then press the meat product again using the meat press 204.

FIG. 2 additionally shows that the electric meat drainer 200 can include a display 218. In at least one implementation, the display 218 can show relevant information to the user. For example, the display 218 can include a fat calculator. A fat calculator can allow the user to determine the amount of FOG removed from the meat product. In particular, the fat calculator can compare the weight of the FOG in the container to the weight of the meat product originally added to the colander 202, as determined by a built in scale, to determine the percentage of the original meat product added to the colander 202 was FOG. Additionally or alternatively, the display 218 can indicate the weight of the FOG and/or the meat product.

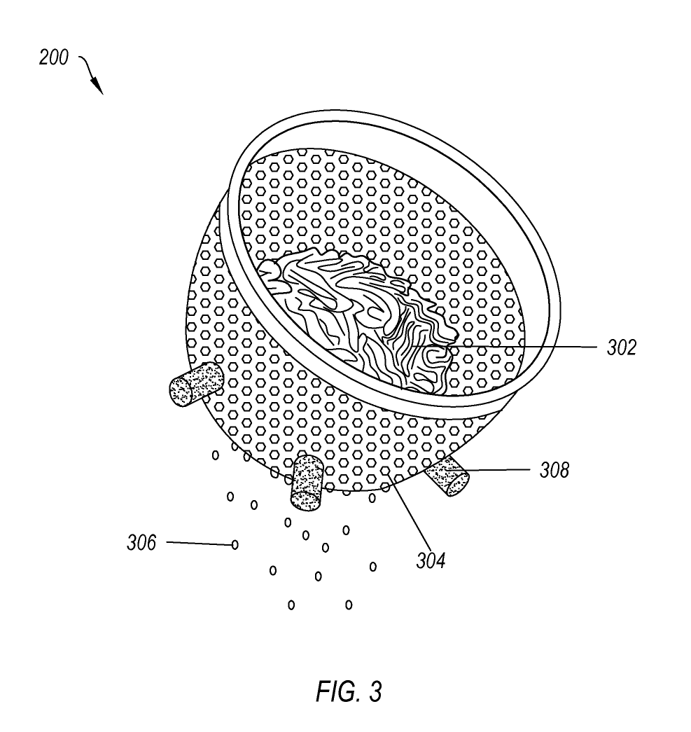

FIG. 3 illustrates an example of a colander 202 for use with an electric meat drainer. In at least one implementation, the colander 202 can retain the meat product while allowing the FOG to remain within the colander 202. I.e., the colander 202 can separate the meat product from the FOG. One of skill in the art will appreciate that the colander 202 can be replaced with any desired container which retains solids while allowing the FOG to be removed. For example, the colander 202 can be replaced with a sieve, a filter or any other desired device. Indeed, any device which performs the same function as the colander 202 is contemplated herein.

FIG. 3 shows that the colander 202 can hold a meat product 302. In at least one implementation, the meat product 302 can include any meat product 202 from which the user desires to remove FOG. For example, the meat product 302 can include hamburger, beef, turkey, pork, chicken or any other meat. I.e., the meat product 302 can include any meat which contains FOG.

FIG. 3 also shows that the colander 202 can include one or more holes 304. In at least one implementation, the holes 304 are large enough to allow the FOG to exit the colander 202. In contrast, the holes 304 are small enough to prevent the meat product 302 from exiting the colander 202. That is, the holes are smaller than the diameter of the majority of the meat product 302.

FIG. 3 further shows that the colander 202 can allow FOG 306 to exit the colander 202. In at least one implementation, the FOG 306 can be collected after exiting the holes 304. For example, the FOG 306 from each hole 304 can be condensed or otherwise combined into large collections of FOG 306 which are likewise combined with one another. The process can be continued until all of the FOG 306 is combined in a single collection.

FIG. 3 additionally shows that the colander 202 can include a frame 308. In at least one implementation, the frame 308 can separate the colander 202 from the device in which it sits. I.e., the frame 308 can include one or more supports which can support the colander 202 and separate the colander 202 from the device in which it sits. The frame 308 allows the FOG 306 to exit the colander 202 without restriction. I.e., if the colander 202 sits in a device which is substantially the same size and shape as the outer surface of the colander 202 the FOG 306 will be unable to exit the holes 304. In contrast, the frame 308 creates a space between the colander 202 and the device, providing space for the FOG 306 to exit the colander 202.

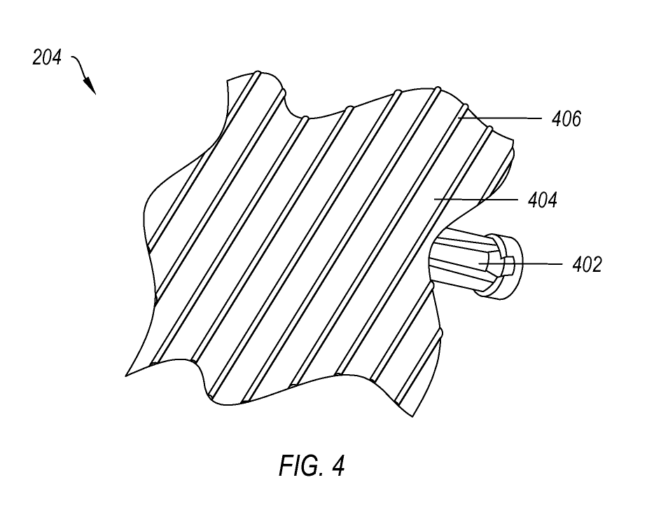

FIG. 4 illustrates an example of a meat press 204. In at least one implementation, the meat press 204 can be used to remove FOG from a meat product. In particular, the meat press 204 can apply pressure to the meat product which separates the FOG from the meat product. For example, the meat press 204 can press the meat product against a colander, which will retain the meat product but allow the FOG to exit.

FIG. 4 shows that the meat press 204 can include an attachment 402. In at least one implementation, the attachment 402 can allow the meat press 204 to be attached to a motor. In particular, the meat press 204 can be attached or removed as desired by a user. For example, the user can attach multiple meat presses 204 if the quantity of meat product is large. In contrast, the user can attach fewer meat presses 204 if the quantity of meat product is small.

FIG. 4 also shows that the meat press 204 can include a surface 404. In at least one implementation, the surface 404 is configured to be in contact with the meat product. In particular, the surface 404 applies the desired pressure to the meat product in order to remove the FOG, as described above.

FIG. 4 further shows that the meat press 204 can include one or more ridges 406. In at least one implementation, the one or more ridges 406 allow the surface 404 to make better contact with the meat product. In particular, the ridges 406 can prevent air bubbles or other areas where the surface 404 is not in contact with meat product.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An electric meat drainer for removing FOG from a meat product, the electric meat drainer comprising:
a container, wherein the container is configured to:
retain a meat product; and
allow FOG to freely exit the container;
a press, wherein the press is configured to:
move relative to the container; and
apply pressure to the meat product within the container, wherein the pressure separates FOG from the meat product, allowing the FOG to exit the container;
a motor, wherein the motor is configured to move the press relative to the container; and
a FOG container, wherein the FOG container is configured to receive the FOG which exits the container.

2. The electric meat drainer of claim 1, wherein the container includes a colander.

3. The electric meat drainer of claim 1, wherein the container includes at least one hole.

4. The electric meat drainer of claim 1, wherein the container includes at least one slit.

5. The electric meat drainer of claim 1, wherein the container includes a mesh.

6. The electric meat drainer of claim 1 further comprising a frame, wherein the frame is configured to elevate the container.

7. The electric meat drainer of claim 1, wherein the press includes at least one ridge.

8. The electric meat drainer of claim 1, wherein the press includes an attachment, wherein the attachment is configured to attach the press to the motor.

9. The electric meat drainer of claim 1, wherein the FOG container includes a plastic container.

10. The electric meat drainer of claim 1, wherein the FOG container includes a lid.

11. The electric meat drainer of claim 1, wherein the FOG container is biodegradable.

12. An electric meat drainer for removing FOG from a meat product, the electric meat drainer comprising:
a container, wherein the container is configured to:
retain a meat product; and
allow FOG to freely exit the container;
a press, wherein the press is configured to:
move relative to the container; and
apply pressure to the meat product within the container, wherein the pressure separates FOG from the meat product, allowing the FOG to exit the container;
a motor, wherein the motor is configured to move the press relative to the container;
a collection chamber, wherein the collection chamber is configured to receive the FOG which exits the container; and
a FOG container, wherein the FOG container is configured to receive the FOG from the collection chamber.

13. The electric meat drainer of claim 12 further comprising a liner, wherein the liner is placed within the collection chamber.

14. An electric meat drainer for removing FOG from a meat product, the electric meat drainer comprising:
a container, wherein the container is configured to:
retain a meat product; and
allow FOG to freely exit the container;
a press, wherein the press is configured to:
move relative to the container; and
apply pressure to the meat product within the container, wherein the pressure separates FOG from the meat product, allowing the FOG to exit the container;
a stirrer, wherein the stirrer is configured to agitate the meat product within the container;
a cover, wherein the cover is configured to shield at least a portion of:
the container;
the press; and
the stirrer;
a motor, wherein the motor is configured to:
move the press relative to the container; and
move the stirrer relative to the container, moving the meat product within the container;
a collection chamber, wherein the collection chamber is configured to receive the FOG which exits the container;
a frame, wherein the frame holds the position of the container relative to the collection chamber;
a FOG container, wherein the FOG container is configured to receive the FOG from the collection chamber;
a scale, wherein the scale is configured to:
measure the weight of the meat product placed in the container; and
measure the weight of the FOG removed from the meat product; and
a display, wherein the display is configured to show to a user the amount of FOG:
in the original meat product; and
removed by the electric meat drainer.

15. The electric meat drainer of claim 14 further comprising a switch, wherein the switch allows the user to begin a draining cycle.

16. The electric meat drainer of claim 15, wherein the switch includes a safety mechanism, wherein the safety mechanism prevents operation of the motor under predetermined conditions.

17. The electric meat drainer of claim 15, wherein predetermined conditions include the cover being open.

18. The electric meat drainer of claim 14 further comprising a timer, wherein the timer is configured to activate the motor to move the press for a predetermined amount of time.

19. The electric meat drainer of claim 18, wherein the timer is further configured to complete a cycle of:
pressing the meat product;
stirring the meat product; and
pressing the meat product.

20. The electric meat drainer of claim 14, wherein at least a portion of the container is within the collection chamber.
